(19) United States
(12) Patent Application Publication
(10) Pub. No.: US 2002/0162237 A1
(43) Pub. Date: Nov. 7, 2002

(54) Sheath for combined string line anchor and plumb bob tool

(76) Inventor: Christopher Shawn Bartimus, Payette, ID (US)

Correspondence Address: PEDERSEN & COMPANY, PLLC, P.O. BOX 2666, BOISE, ID, 83701, US

(21) Appl. No.: 10/062,891

(22) Filed: Jan. 30, 2002

Related U.S. Application Data
(63) Continuation-in-part of application No. 09/847,614, filed on May 2, 2001.

(51) Int. Cl. G01C 15/10

(52) U.S. Cl. 33/392

(57) ABSTRACT

Embodiments of a sheath for a pointed tool are described, which tool may be a combination string/chalk line anchor and plumb bob. The sheath includes a cavity for housing the pointed needle or spike that extends out from the combination tool, and a cavity for at least partially encircling the body of the tool. A locking mechanism is included to secure the tool in the sheath until removed is desired. The sheath may include a system for attaching it to a chalk box, and a slot defining an exit-point for string line to extend out from the sheath to the chalk box or other container or spool.

This application is a continuation-in-part of, and claims priority from, U.S. patent application Ser. No. 09/847,614, filed on May 2, 2001, entitled “A Combined String Line Anchor and Plumb Bob,” the disclosure of which is incorporated herein by this reference.

### BACKGROUND OF THE INVENTION

1. Field of the Invention

This invention relates generally to construction and carpentry equipment and tools, and more particularly to anchoring devices for string/chalk lines and/or to plumb bobs. In particular, this invention relates to a protector and holder for a pointed, multifunction tool that serves both as a chalk line anchor and as a plumb bob.

2. Related Art

In building construction and carpentry projects, alignment strings and chalk lines are frequently used to confirm or establish straight lines. Such string or line systems have one portion that serves to store the unused portion of the string, e.g. a simple ball of string or, as is often the case, a reel of some sort to pay-out and pay-in the line. The other “free” end of the line is usually held by an assistant or anchored by a mechanical device. Such mechanical devices typically include a nail, an awl, or a stickpin, for example. Frequently, commercial chalk lines include an L-shaped hook with an eyelet tied to the line's free end. The hook is used to anchor the line over the edge of a workpiece. After the chalk line is properly positioned, the line is plucked near its center to cause a chalk mark to be left on the surface of the underlying material.

All of the above-mentioned anchoring devices see considerable use at construction job sites. The stickpin is one of the more commonly-used string line anchoring devices. These pins are about the size of an adult finger and have the general shape of the body of a dart (without feathers). The forward end of the stickpin, as in a dart, includes a highly sharpened needle like point. In use, the string is tied around an annular groove in the stickpin, the pin is pressed by hand into the work surface and the line is then looped around the needle portion immediately adjacent to the work surface. The other end of the line is then pulled to tighten the string against the stickpin. The needle portion of the stickpin is typically formed from a high strength steel so that it may be pushed by hand, without damaging the point, into a variety of non-metallic materials, such as wood, plywood, sheet-rock, etc.

Plumb bobs are also frequently used by carpenters and other construction industry professionals. As is well known, a plumb bob is used to determine the “plumbness” or verticality of a wall, stud column, etc. It also is used to vertically transfer a point at one elevation to another elevation.

In laying out construction projects, plumb bobs are frequently used in concert with string lines and chalk lines. The instant inventor has previously invented combined string line anchor and plumb bob tools, such as in U.S. Pat. No. 5,720,113 (issued Feb. 24, 1998) and in the application from which this application claims priority, Combined String Line Anchor and Plumb Bob, Ser. No. 09/847,614. These tools integrate features of a string/chalk line stickpin anchoring device and a plumb bob, to increase the efficiency of the carpenter and reduce overall expenses to the project.

In U.S. Pat. No. 5,720,113 (“'113”), the multi-function tool has a point at its distal end, and a recess and clamping system for mounting on the tool an L-shaped hook of the type conventionally used for attaching a string line over an edge of a work-piece. The '113 tool includes a channel through the proximal end of the tool so that the string line may extend out of the tool at the axial centerline, and a cap on the proximal end that may be removed to reveal the channel, and may be tightened onto the tool to move a slidable jaw to hold the hook in place in the tool.

The tool of Ser. No. 09/847,614 (“'614”) includes an external channel system through which the string line may extend to exit the tool at the axial centerline of the tool. In addition, the '614 tool includes an adjustable pointed spike that may be moved axially to protrude various amounts out from the body of the tool. This adjustability feature allows the tool body to serve as a fixed stop for the insertion of the needle into materials of differing hardness so that the sharpened spike is not inserted into the wood or other material farther than is needed to satisfactorily anchor the string. Also, the adjustability feature reduces the risk of breaking the point when it is inserted too far. If the sharpened spike is broken, it may be removed from the tool and replaced with another adjustable spike, further increasing the efficiency of the carpenter and decrease his/her equipment costs.

Thus, the integrated string line anchoring device and a plumb bob provides a simple, but useful, economical, and efficient tool that is reusable and effective for a long period of time. As a means of protecting the tool and preventing dulling or breakage of the tool point, and preventing injury by the tool point, a cover or sheath for the tool is needed. The instant invention meets this need, in an effective, economical, and easily-used sheath that allows the tool to be safely and comfortably carried in a tool box, on a chalk box, or by other means.

### SUMMARY OF THE INVENTION

This invention comprises a sheath for a pointed tool, such as a combination string line anchor and a plumb bob. The sheath serves as a cover for the point of the tool, a protector for the tool in general, and a system for connecting/mounting the covered tool on a chalk box or other container or workplace item. In this Description and in the claims, the terms “string line” or “string” includes strings, cables, cords, strips, lines, or other elongated flexible members for attachment to the tool, and used with or without chalk or other materials and substances. In the Description and in the claims, the term “pointed spike” includes the preferred needle-like member, but also may be other sharpened elongated members.

The sheath is generally elongated and comprises an internal cavity with a spike-receiving portion for receiving the distal (forward) end of the tool including the pointed needle or spike, and a body-receiving portion for receiving the central body of the tool. The sheath also includes a lock system that secures the tool in the sheath until the user purposely releases the lock to remove the tool. The sheath preferably includes a base with a generally planar outer surface for resting on an object or for attachment to a chalk box or other surface. The sheath preferably includes a slot for the string line that allows the string line to exit the sheath to extend to a chalk box or a take-up reel and that helps prevent tangling of the string line.

By inserting and locking the tool in the invented sheath, the point of the tool is much less likely to become dull or broken from abrasion or impact by nails, other tools, or other objects in a tool box, nail box, or vehicle bed, for example. Also, when the sheath covers the point, the tool is unlikely to hurt people, animals, or materials and surfaces. With the tool secured via the sheath to a chalk box, for example, the tool is easily located when needed and is kept close to the equipment with which it is normally used.

A preferred feature of the sheath is that it is sized and shaped in such a way that the tool will not fit or lock into the sheath if the point spike or needle of the tool extends out from the tool beyond a certain length. This way, the sheath may be designed to cooperate only with a tool that has a spike sized or adjusted to what may be considered a relatively safe length.

These and many other features and attendant advantages of the invention will become apparent as the invention becomes better understood by reference to the following detailed descriptions and accompanying drawings.

### BRIEF DESCRIPTION OF THE DRAWINGS

FIG. 1 is a rear perspective view of one embodiment of the invented sheath.

FIG. 2 is a front perspective view of the sheath of FIG. 1, with one embodiment of a combined anchor and plumb bob tool inserted and locked into the sheath.

FIG. 3 is a rear perspective view of the sheath of FIGS. 1 and 2, with the tool of FIG. 2 distanced from the sheath.

FIG. 4 is a rear perspective view of the sheath of FIGS. 1-3, with the tool of FIGS. 2 and 3 inserted and locked into the sheath.

FIG. 5 is a rear perspective view of the sheath of FIGS. 1-4, attached to a top surface of a carpenter's chalk box.

FIG. 6 is a rear perspective view of the sheath of FIGS. 1-5, attached to a side surface of the carpenter's chalk box.

FIG. 7 is a top view of the sheath of FIGS. 1-6.

FIG. 8 is a side view of the sheath of FIGS. 1-7.

FIG. 9 is a bottom view of the sheath of FIGS. 1-8.

FIG. 10 is a side, cross-sectional view of the sheath of FIGS. 1-9, with the tool of FIGS. 2-6 shown in cross-section in the sheath.

FIG. 11 is rear perspective view of the sheath of FIGS. 1-10, at an angle that allows viewing deep into the tool-receiving cavity of the sheath.

FIG. 12 is an alternative embodiment of a combined anchor tool and plumb bob that may be used with an embodiment of the invented sheath.

### DESCRIPTION OF THE PREFERRED EMBODIMENTS

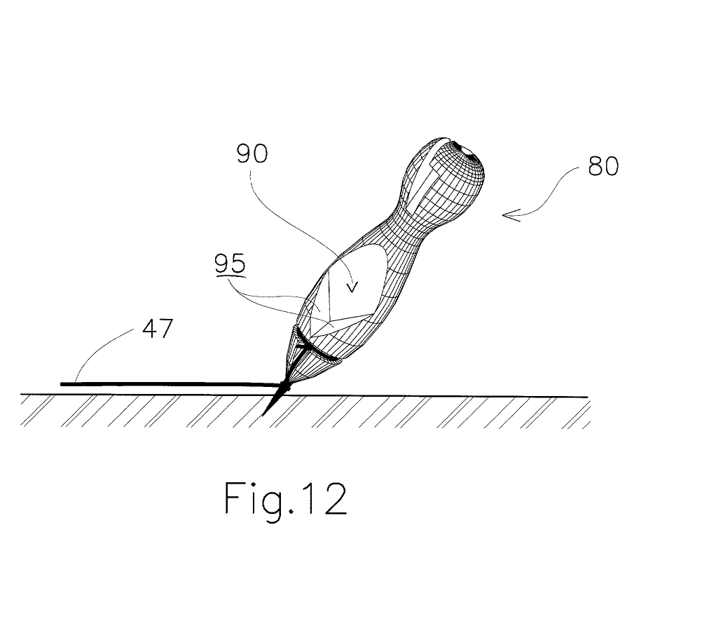

Referring to the Figures, there is shown one, but not the only, embodiment of the invented sheath for a pointed tool. In particular, the preferred sheath is adapted to receive, cover, and protect a combination string line anchor and plumb bob tool. While various combination string line anchor and plumb bob tools may be used in the invented sheath, the preferred tool is shown in the Figures as the type described in U.S. Pat. No. 5,720,113 by the present inventor. The combination anchor and plumb bob tool described in U.S. patent application Ser. No. 09/847,614 and portrayed in this application's FIG. 12, or other tools with pointed tips, may also be used with various embodiments of the invented sheath, wherein some adaptation may be made to the sheath or to the tool so that the sizes and lengths of the cavities in the sheath are appropriate and so that the locking system of the sheath catches properly on a recess or protrusion of the tool.

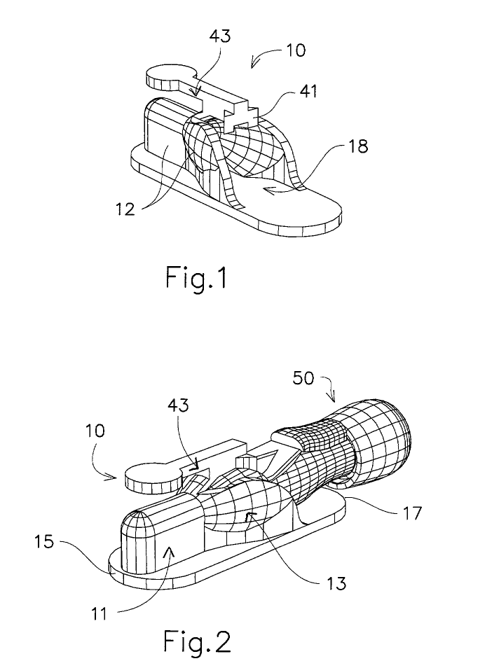

In FIG. 1, there is shown the preferred sheath 10, in an empty state. The sheath 10 comprises a cavity wall 12 with a front portion 11 and a rear portion 13, wherein the cavity wall 12 surrounds and defines an interior cavity. The interior cavity comprises a forward cavity portion 14 at the sheath front end (distal end) 15, a rearward cavity portion 16 generally central between the front end 15 and the sheath rear end (proximal end) 17, and an opening 18 into the interior cavity at the rearward cavity portion. Forward and rearward cavity portions 14, 16 and opening 18 preferably lie in series coaxially on the sheath longitudinal centerline or “longitudinal axis.” The forward cavity portion 14 is adapted to receive the pointed end of the tool 50, particularly, the portion of the pointed spike 52 protruding from the tool body 54. The rearward cavity portion 16 is adapted to receive the forward end of the tool body 54 so that the generally conical surface 56 of the tool abuts against the front, inside surface of the rearward cavity, herein also called the limiting surface 20. This surface 20 serves as a stop to limit forward movement of the tool, so that the tool may only be inserted to a certain extent, no matter how small a distance the pointed spike 52 extends from the body 54. The limiting surface 20 results in a certain location for the tool body 54 along the longitudinal axis of the sheath, which certain location is preferably the proper location for locking of the tool in the sheath by the preferred locking system 40, as further discussed below. In embodiments in which the spike 52 is adjustable in and out from the body, this limiting surface feature is beneficial as it prevents a tool from being placed in the sheath with the spike 52 extended far outward from the body. While the preferred limiting surface 20 and cooperating tool surface 56 are described as generally conical, they may also be called “conoidal” or “bullet-shaped” as their conical walls are curved as in a conventional bullet shape. Alternatively, other cooperating/mating shapes may be used, which preferably do not allow “wiggle” or “rattling” of the tool in the sheath.

When the tool is inserted into the sheath and locked into place with the generally conical surface 56 against the limiting surface 20, there is preferably only ⅝ inch of distance from the front tip 60 of the tool body to the forward inner surface 22 of the forward cavity portion 14. This way, only a maximum of ⅝ inch of spike 52 may protrude from the tool if the tool is to fit in, and lock into, the sheath 10. A protruding spike length of ⅝ inch is sufficient for nearly all construction materials, and the inventor believes that this adjustment is useful as well as safe, if handled in a reasonable way. With the sheath being designed for this maximum spike protrusion length, the tool is more likely to remain in the relatively safe ⅝ inch maximum spike configuration, so that it is less likely to be used in an unsafe way. If the spike 52 is adjusted outward farther than ⅝ inch, the tool will no longer fit into the preferred sheath 10. If the spike 52 is adjusted inward to less than ⅝ inch, then the tool may be even safer, and the tool will fit and lock properly into the sheath.

The limiting surface 20 also serves to stabilize the tool inside the sheath, due to the generally conical shape of the surface 20 corresponding to the generally conical surface 56 of the tool. The sheath conical surface 20 preferably curves at least about 200 degrees around the tool, and, more preferably, at least about 260 degrees. The embodiment shown in the Figures features a rearward cavity portion wall that extends about 280 around the tool. Once the tool is in place in the sheath, these closely adjacent and curved surfaces 20, 56 tend to prevent movement transverse to the longitudinal axis, and, most preferably, to prevent other than longitudinal movement of the tool in a rearward direction relative to the sheath.

The forward cavity 14, on the other hand, serves mainly to contain and cover the pointed spike, rather than to stabilize the tool by preventing movement of the tool. Preferably, the spike does not abut or stick into the inner surface 22. The forward cavity exterior has a generally elongated shape of a smaller width and height than the rearward cavity portion 16, with a curved top surface 28 and front surface 30. The inner surface of the rearward cavity preferably transitions smoothly to the inner surface of the forward cavity, so that, during insertion of the tool, if the spike slides along the cavity interior surface, it slides smoothly and is, in effect, guided from the rearward cavity portion into the narrower forward cavity portion.

The locking system 40 preferably automatically engages or sets when the tool 50 is inserted into the sheath 10, and is released only manually when the user wishes to remove the tool. Preferably, the locking system 22 comprises a latch 41 that catches in a recess 62 in the tool body 54 when the tool slides into place against the limiting surface 20. The latch is preferably biased into the closed position, that is, biased inward toward the center of the cavity, and, hence, toward the tool surface. The latch preferably “snaps” into the tool recess when the tool is properly in place in the sheath. This way, the tool is easily and conveniently sheathed, and yet is not easily accidently unlocked or dropped out of the sheath. The recess 62 into which the latch 41 snaps is preferably the recess in which the L-shaped hook (call-out 64 in this application) resides when captured in the tool as described in U.S. Pat. No. 5,720,113. The forward wall 65 of the recess 62 is the wall against which the latch abut, thus preventing rearward movement of the tool out of the sheath.

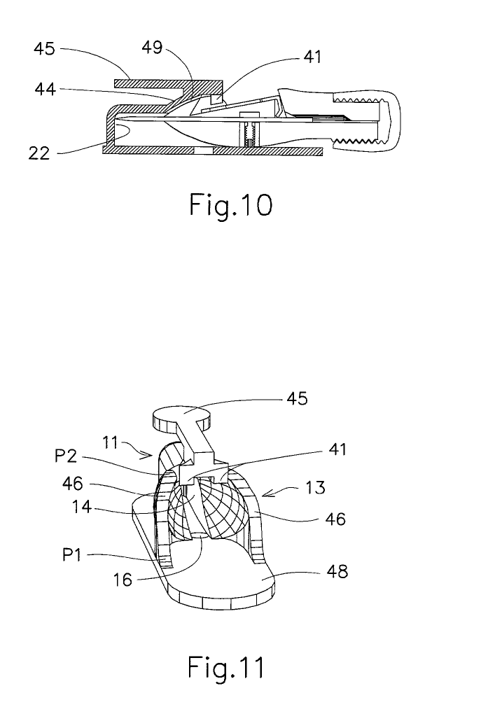

When the user wishes to remove the tool from the sheath, he/she may actuate an unlatching means, such as a manual handle that lifts the latch 41 out of the recess 62. The preferred lock mechanism comprises a lock member 43 that integrally connects to the top of the cavity wall at a connection region 44 (also called “hinge region”). The lock member 43 extends generally parallel to the longitudinal axis of the sheath above the top surface of the cavity wall 12. From the connection region 44, the lock member extends forward to form the handle 45 and rearward to form the latch 41. The handle 45 extends in a forward direction generally parallel to the top surface 28 of the forward cavity wall, with the handle being distanced from the top surface 28. Pressure on the handle 45 toward the top surface 28 causes the connection region and/or the cavity wall in that area to flex slightly, so that the lock member 43 pivots generally at the connection region 44 to raise the latch 41 up out of the recess 62. Thus, the connection region may be considered a hinge, hinge region, or pivotal connection, as the connection region 44 acts to allow the lock member 43 to pivot relative to the rearward cavity wall portion 13. Tool 50 can then be pulled longitudinally rearward outward of the sheath. When the pressure on the handle is released, the resiliency of the connection region and the cavity wall near region 44 returns the lock member 43 to its starting position, with the latch 41 biased toward the centerline of the sheath to be slightly closer to the centerline than is the inner surface of the rearward cavity portion at the rearward edge of the cavity wall, as best shown in FIG. 10. In effect, a fulcrum is created at or near the attachment of the lock member 43 to the sheath wall (“cavity wall”), allowing the lock member 43 to be biased into the latched position and to pivot to raise the latch into the unlatched position.

One may note that the rear edge 46 of the cavity wall curves, from a position P1 on the base 48 about ⅓ of the base length from the rear end 17, upwards and forward to a position P2, which is about ⅔ of the base length from rear end 17 and which is forward from the latch end of the lock member. In other words, the lock member extends rearward beyond the rear edge 46 of the cavity wall, so that, in effect, the rearward latch end of the lock member extends rearward past the cavity wall, over the opening 18, substantially unsupported by, and unconnected to, the cavity wall except at the connection region 44. This way, the lock member connection region flexes more readily relative to the rest of the sheath, allowing the biased latching and handle-actuated unlatching described above.

The lock member 43 is long enough and extends rearward enough that, when it is biased to pivot the latch end down toward the longitudinal axis of the sheath, the latch end preferably extends down in back of the opening. While the latch end does not necessarily extend into the plane of the opening itself, it may be said to extend “across the opening” when it is rearward and near to the opening.

While various ways of attaching the lock member 43 to the cavity wall may be used, and various ways of forming the biasing means and the pivoting fulcrum may be used, the preferred ways comprise integral molding of the plastic lock member as part of the plastic sheath. This way, the natural resilience of the plastic of the sheath wall, and the lock member connection region may be used to create the biasing that latches the tool in place. Preferably, the sheath is made by molding plastic, preferably a plastic or plastics that are durable and that allow the hinge area (“connection region”) to be sufficiently flexible and resilient to properly operate the lock system. The plastic may be chosen and the thickness and shape of the lock bar attachment area and the adjacent cavity wall areas are chosen so that the flexing moves the latch upwards a sufficient distance to unlatch the tool. The biasing of the latch system into the closed, locked position against the tool wall may comprise the resilience of the plastic that moves the lock bar back into its original position when the handle is no longer being pressed.

While the preferred recess 62 of the tool, into which protrudes the latch 41, is the recess adapted to also receive the L-hook of the tool from U.S. Pat. No. 5,720,113, other recesses or fasteners for cooperating with a latch or lock on the sheath may be used. For example, an alternative recess, such as the thumb-hole recess of the tool in patent application Ser. No. 09/847,614, may be used, in which case the tool 80 thumb-hole recess 90 may be adapted to have a recess front wall 95 that is transverse to the longitudinal axis of the tool or slanted forward from the top of the wall to the bottom of the wall, so that the latch of the sheath “catches” on the recess wall.

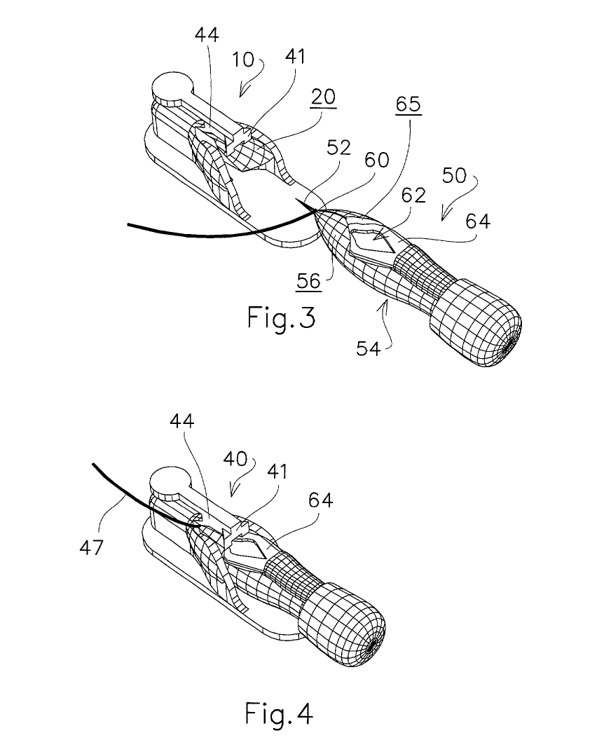

A slot through the cavity wall is preferably provided for passage of the string line from the interior cavity to outside the sheath. As shown in FIG. 3, the string line 47 is normally wrapped around or otherwise connected to the spike 52 when the tool is inserted into the sheath. The string line, therefore, extends rearward from the spike and out of the internal cavity through the slot 49. Preferably, the slot 49 extends at its forward end to approximately the border between the forward cavity portion and rearward cavity portion, so that the string line 47 may exit the interior cavity without lying between the conical surface 56 of the tool body 54 and the limiting surface 20 of the internal cavity. This way, the string line 47 is not trapped or pinched between the conical surface 56 and the limiting surface 20. The slot 49 is sized so that the string line 47 is not pinched or pressured to an extent that would, even after repeated sheathings, damage or weaken the string. After passing through the slot, the string line preferably extends into a chalk box 70 or is taken-up by other means, such as being wound on a spool or other object. By positively locating the string line's exit from the sheath and by containing/taking-up the length of the string line in a chalk box or other container or holder, tangling and knotting of the string line are minimized.

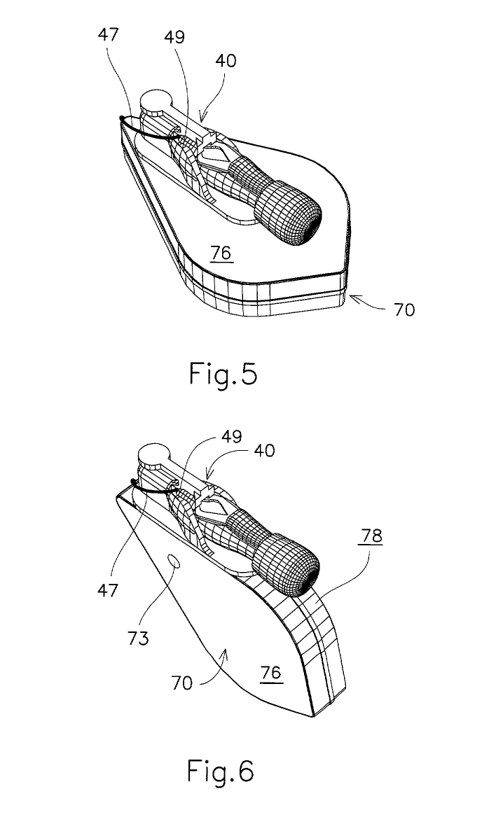

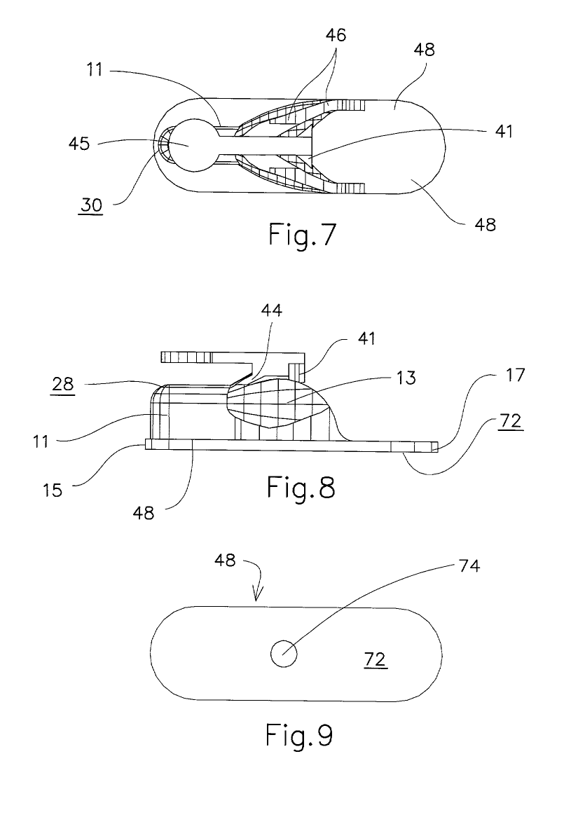

As illustrated in FIGS. 5, 6 and 9, the sheath 10 preferably is adapted for attachment to a chalk box 70 or other object, to further aid in preventing tangling of the string line and/or damage to the sheath and tool that might otherwise occur if the sheath and tool are stored or transported loose in a tool box or vehicle. The preferred adaptation comprises a base 48 positioned underneath the cavity wall that has a generally planar platform surface 72 upon which the sheath may rest. The base 48 includes means for attachment to the chalk box or other object, preferably, an aperture 74 for receiving a screw or bolt that may extend, for example, into an attachment hole 73 in the chalk box. The sheath 10 is preferably fastened by means of a screw (not shown) through the aperture 74 to a carpenter's chalk box 70, either on a top surface 76 or on a side surface 78. The string line extends from the slot 49 to the string line hole (not shown) in the chalk box 70 and preferably all of the length of the string line is contained within the chalk box until use of the tool and the string line. This way, the chance of tangles and damage to the string line and to the tool is minimized, and the tool is unlikely to be lost or to do damage to people or materials. Alternatively, the sheath 10 may be molded or otherwise formed as an integral part of a chalk box 70 or tool box, for example.

Preferably, the base 48 is sized to provide a stable platform for the sheath. The base 48 preferably extends forward beyond the front portion 11 of the cavity wall to be the frontmost extremity of the sheath. The base 48 preferably extends rearward beyond the rear edge 46 of the rear portion 13 of the cavity wall to be the rearmost extremity of the sheath. Also, the base 48 extends transversely to the longitudinal axis to extend at least underneath, or out past, both sides of the sheath cavity wall.

With the tool 50 housed in the sheath 10 attached to the chalk box 70, the tool may be easily withdrawn from the sheath, as detailed above, by pressing on the handle 45 and pulling out the tool. Because the sheath is secured to the chalk box, the tool may be easily removed without the sheath tipping over or moving during the operation. The tool 50 may then be moved away from the chalk box 70 to pull the string line out of the chalk box, coated with chalk, for use. Use of the tool, either as an anchoring device for chalk line marking or as a plumb bob, may be done according to the techniques described in U.S. patent application Ser. No. 09/847,614, from which this application claims priority and which is incorporated herein, and/or described U.S. Pat. No. 5,720,113.

The inventor envisions that other tools, and especially other combined anchor and plumb bob tools, may be used in the invented sheath. Some modification to the sheath may be necessary, for example, to lengthen or adapt the locking mechanism. Or, some modification to the tool may be necessary, for example, to supply a recess or other structure for cooperating with a locking system to retain the tool in the sheath.

Although this invention has been described above with reference to particular means, materials and embodiments, it is to be understood that the invention is not limited to these disclosed particulars, but extends instead to all equivalents within the scope of the following claims.

I claim:

1. A sheath and string-line tool combination comprising:
a tool having a tool body with a front end and a recess, a pointed member protruding from the front end, and a string having a first end and a second end, the first end being attached to the tool;
a sheath having a sheath front end and a sheath rear end, a longitudinal axis between said sheath front end and said sheath rear end, a cavity wall surrounding and defining an interior cavity with an opening receiving the tool, wherein the interior cavity has a forward portion receiving the pointed member and a rearward portion receiving at least a part of the body of the tool;
a locking system adapted to releasably lock the tool in the sheath, the locking system comprising a latch that is biased to extend into said recess of the tool body to prevent removal of the tool from the sheath.

2. The combination of claim 1, wherein said rearward portion of the interior cavity has a limiting surface near said forward portion of the interior cavity, and, when the tool is received in the sheath, the tool body abuts against said limiting surface to limit forward movement of the tool in the interior cavity, and the pointed member extends into the forward portion of the interior cavity.

3. The combination of claim 1, wherein said tool body has a rear end, and a tool longitudinal axis between the front end and the rear end, a side surface generally parallel to the tool longitudinal axis, and said recess is in said side surface, and wherein the forward portion and rearward portions of the interior cavity and the opening are aligned generally coaxially on the sheath longitudinal axis, and the locking system comprises a lock member connected to the cavity wall extending generally parallel to the sheath longitudinal axis and pivotal in a plane passing through said sheath longitudinal axis, wherein a rearward end of the lock member is said latch and the lock member is biased to pivot the latch toward the sheath longitudinal axis rearward of said opening.

4. The combination of claim 3, wherein the lock member integrally extends from the cavity wall, and the lock member pivots in said plane passing through said sheath longitudinal axis by means of a portion of the cavity wall to which the lock member is connected flexing in direction parallel to said plane.

5. The combination of claim 1, wherein the sheath further comprises a base with a planar outer surface adapted for attachment to a chalk box.

6. The combination of claim 1, wherein the sheath cavity wall has a slot through which said string passes from the forward portion of the interior cavity to outside the sheath.

7. The combination of claim 1, wherein the forward portion of the interior cavity has a length coaxial with the sheath longitudinal axis that is less than or equal to ⅝ inch so that a tool with a pointed member longer than ⅝ inch will not slide into the sheath far enough forward to allow the latch to extend into said recess of the tool body to lock the tool in the sheath.

8. The combination of claim 1, wherein the pointed member is a sharpened spike.

9. A tool sheath and chalk box combination comprising:
a sheath for a string-line anchor tool having a tool body, a pointed member and a string, the sheath having a sheath front end and a sheath rear end, a longitudinal axis between said sheath front end and said sheath rear end, a cavity wall surrounding and defining an interior cavity with an opening adapted to receive the anchor tool, wherein the interior cavity has a forward portion adapted to receive the pointed member and a rearward portion adapted to receive at least a part of the tool body;
a locking system adapted to releasably lock the anchor tool in the sheath; and
a chalk box containing chalk for coating the string of the anchor tool;
wherein the sheath is attached to the chalk box.

10. The combination of claim 9, wherein said rearward portion of the interior cavity has a limiting surface near said forward portion of the interior cavity, and wherein said limiting surface is adapted to limit forward movement of the anchor tool in the interior cavity.

11. The combination of claim 9, wherein the forward portion and rearward portions of the interior cavity and the opening are aligned generally coaxially on the sheath longitudinal axis, and the locking system comprises a lock member connected to the cavity wall extending generally parallel to the sheath longitudinal axis and pivotal in a plane passing through said sheath longitudinal axis, wherein the lock member has a rearward latch end and the lock member is biased to pivot the latch end toward the sheath longitudinal axis rearward of said opening.

12. The combination of claim 11, wherein the lock member integrally extends from the cavity wall, and the lock member pivots in said plane passing through said sheath longitudinal axis by means of a portion of the cavity wall to which the lock member is connected flexing in direction parallel to said plane.

13. The combination of claim 9, wherein the sheath comprises a base with a planar outer surface attached to the chalk box.

14. The combination of claim 9 wherein the sheath cavity wall has a slot through which said string passes from the forward portion of the interior cavity to outside the sheath and into the chalk box to be in contact with the chalk.

15. The combination of claim 9, wherein the forward portion of the interior cavity has a length coaxial with the sheath longitudinal axis that is less than or equal to ⅝ inch so that an anchor tool with a pointed member longer than ⅝ inch will not slide into the sheath far enough forward to allow the locking system to lock the anchor tool in the sheath.

16. A sheath system for a combination string-line anchor and plumb bob tool, the tool having a tool body and a pointed spike extending forward from the tool body and a string extending from the tool, the sheath system comprising:
a sheath having a sheath front end and a sheath rear end, a longitudinal axis between said sheath front end and said sheath rear end, a cavity wall surrounding and defining an interior cavity with an opening adapted to receive the tool, wherein the interior cavity has a forward portion adapted to receive the pointed spike and a rearward portion adapted to receive at least a part of the body of the tool;
a locking system adapted to releasably lock the tool in the sheath, the locking system comprising a lock member connected to the cavity wall and that is pivotal in a plane parallel to the longitudinal axis of the sheath, the lock member having a rearward latch end and a forward handle end, wherein the lock member is biased to place the rearward latch end generally across a portion of the opening for extending into a recess of the tool body rearward of the opening to prevent removal of the tool from the sheath, and wherein the forward handle end is adapted, when pressed toward the cavity wall, to pivot the lock member so that the rearward latch end rises away from the opening.

17. A sheath system as in claim 16, further comprising a chalk box containing chalk, wherein the sheath is attached to the chalk box.
